(19) United States
(12) Patent Application Publication
(10) Pub. No.: US 2007/0240122 A1
(43) Pub. Date: Oct. 11, 2007

(54) Method, system and program storage device for providing request trace data in a user mode device interface

(76) Inventors: Chiahong Chen, Tucson, AZ (US); Radha K. Ramachandran, Tucson, AZ (US)

Correspondence Address: DAVID W. LYNCH;CHAMBLISS, BAHNER & STOPHEL, 1000 TALLAN BUILDING-T, TWO UNION SQUARE, CHATTANOOGA, TN, 37402, US

(21) Appl. No.: 11/398,191

(22) Filed: Apr. 5, 2006

(51) Int. Cl. G06F 9/44

(52) U.S. Cl. 717/128

(57) ABSTRACT

A method, system and program storage device for providing request trace data in a user mode device interface. A trace utility of a user device interface generates a device open packet having request trace data therein for forwarding to a main user application trace facility in response to receipt of a device interface request from a client application.

### BACKGROUND OF THE INVENTION

1. Field of the Invention

This invention relates in general to a computer programming, and more particularly to a method, system and program storage device for providing request trace data in a user mode device interface.

2. Description of Related Art

In a highly competitive market environment, “time to market with superior quality” is the key focus in developing a new product. For a well-established development team with years of experience in software development, the reusability of existing software is the very key to achieving the goals of delivering a new product in the most efficient way with superior quality. Given the stiff competition in the market environment, what a new product is required to do is constantly increasing and how much it is allowed to cost is reducing. For a software product development, the demanding requirements and pressure of lowering cost are translated into the need for the reuse of existing software functions in various hardware platforms. One of the focus items to achieve high software reusability is to develop the software functions with the encapsulation of a platform they are operating on. The platform includes the actual hardware and the operating systems.

One key consideration in selecting a platform for a product is whether the software can best perform in privileged mode or user mode. The traditional thinking is software can best perform in privileged mode. However, given the advancing technology in hardware platform development, operating in user mode may be a much better choice given different product requirements. The built-in protection provided by all modern operating systems for a software running in user mode, the ease of managing a program in a user mode, and the improved system stability with new software functions isolated from kernel are significant benefits of implementing a software project in user mode.

For a software product family to maintain high reusability across a range of products that may be operating in various platforms, a consistent device interface is a key for the software functions it provides to be invoked consistently. A software product consists of a set of key software components and software applications, which may be implemented as collaborating privileged and user mode applications to provide the functionality intended by the software product. In a user mode implementation of a real-time software application, the software product also provides a user mode device interface using socket interface.

For a real-time user application to run on a particular platform that has a relatively small file system using Compact Flash (CF) memory, it must manage the resource allocation within the file systems space constraints. In order to provide proper maintenance and support for the user mode device interface, it is critical to build in First Time Data Capture (FTDC) capability in this interface. In this case, the main user application includes the device interface server and it has a rich set of run-time trace functions. The trace is easily accomplished on the device interface server side. However, on the device interface client side, which is typically a utility program making a device interface request to the device interface server, the trace facility relies on what is available if any at all in the design of the utility program. In the device interface, there is a key trace requirement that traces which program (with program name) is making which device interface request at the time when a request is made. Such information is only available in a utility program. Unfortunately, most of the utility programs use a primitive command, such as “printf”, to print out text strings to standard output or log files during program execution as the only trace facility.

There are several problems with this approach. First, if the printf output is only for standard output, such trace is only useful when a user is “watching” the screen, which is very limited to a service person with privileged authority to gain such access in a customer environment. Such trace is only useful in a development environment.

Second, if the text strings are saved to a log file, the owner of the utility program will then have additional responsibility and work to ensure the log file is managed under another system management program so the log file will not take up too much space in the file system over time. Without proper management of a log file by a long running program, the log file may eventually fill up the file systems and cause the whole system to crash in the worst case.

There is a need for a method, system and program storage device for providing request trace data in a user mode device interface without creating additional utility log files.

### SUMMARY OF THE INVENTION

To overcome the limitations in the prior art described above, and to overcome other limitations that will become apparent upon reading and understanding the present specification, the present invention discloses a method, system and program storage device for providing request trace data in a user mode device interface.

The present invention solves the above-described problems by providing a trace utility for a user device interface. The trace facility is incorporated in a user mode device interface. Upon the receipt of a device interface request from a client application, it sends a “device open” packet, which includes request trace data, to the main server application. The main server application then generates a trace entry on behalf of the client application making the user mode device interface request.

A user device interface according to an embodiment of the present invention includes a trace utility for generating a device open packet having request trace data therein for forwarding to a main user application trace facility in response to receipt of a device interface request from a client application.

In another embodiment of the present invention, a computing system is provided. The computing system includes a processor having a user mode and a protected kernel mode and a memory, coupled to the processor, the memory including program code, executing in the processor, for providing a user mode device interface, the user mode device interface processing a device interface request by generating a device open packet having request trace data therein for forwarding to a main user application trace facility in response to receipt of a device interface request from a client application.

In another embodiment of the present invention, a program storage device that includes program instructions executable by a processing device to perform operations for providing a user mode device interface for providing request trace data is provided. The operations include generating a device open packet having request trace data therein in response to receipt of a device interface request from a client application and forwarding the device open packet having request trace data therein to a main user application trace facility.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 illustrates a block diagram of a computer system according to an embodiment of the present invention;

FIG. 2 shows the user mode and kernel mode states according to an embodiment of the present invention;

FIG. 3 illustrates an architecture of a computer system;

FIG. 4 is a diagram showing operation of user mode device interface according to an embodiment of the present invention;

FIG. 5 illustrates interactions between a client side, a server side and a user device interface according to an embodiment of the present invention;

FIG. 6 illustrates a data packet structure for providing a trace utility for a user device interface according to an embodiment of the present invention;

FIG. 7 is a flow diagram of a method for providing a trace utility for a user device interface; and

FIG. 8 illustrates a system according to an embodiment of the present invention.

### DETAILED DESCRIPTION OF THE INVENTION

In the following description of the embodiments, reference is made to the accompanying drawings that form a part hereof, and in which is shown by way of illustration the specific embodiments in which the invention may be practiced. It is to be understood that other embodiments may be utilized because structural changes may be made without departing from the scope of the present invention.

The present invention provides a method, system and program storage device for providing request trace data in a user mode device interface. A trace utility for a user device interface is provided. The trace facility generates a device open packet having request trace data therein for forwarding to a main user application trace facility in response to receipt of a device interface request from a client application.

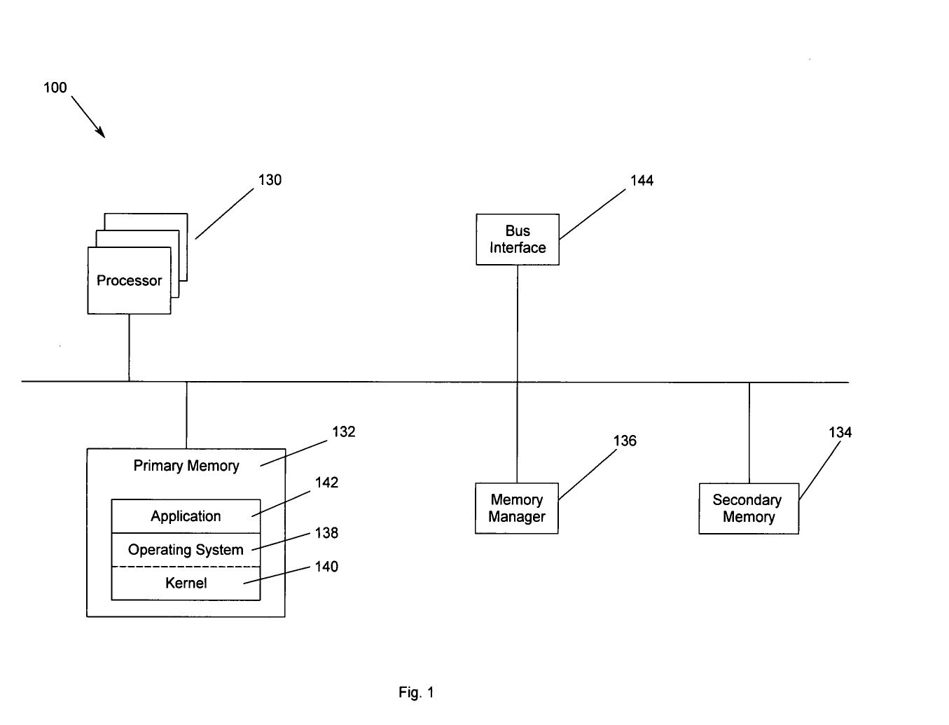

FIG. 1 illustrates a block diagram of a computer system 100 according to an embodiment of the present invention. In FIG. 1, the computer system 100 includes one or more processors 130, which are each capable of executing a thread within one of a number of concurrent multithreaded processes. As is typical in multitasking data processing systems, each user process may be allocated its own virtual memory space, which may be mapped partially into a high-speed primary memory 132 and partially into a lower speed secondary memory 134 by memory manager 136.

The computer system 100 and the allocation of system resources to the computer system 100 are controlled by operating system 138. For the purpose of the present discussion, it is assumed that operating system 138 is resident within primary memory 132, although those skilled in the art will appreciate that certain infrequently utilized segments of operating system 138 may be swapped out to secondary memory 134 by memory manager 136. Operating system 138 includes kernel 140, which comprises the lowest layer of operating system 138 that interacts most directly with the computer system 100. Kernel 140 dispatches kernel threads to processors 130 for execution, provides services to device drivers interfacing with hardware within computer system 100, and implements system services, memory management, network access, and the file system utilized by computer system 100. In addition to kernel 140, primary memory 132 also stores frequently utilized segments of application software 142. As is well known to those skilled in the art, application software 142 communicates with operating system 138 through an Application Programming Interface (API).

Computer system 100 also includes bus interface 144 through which multiple nodes can interface to system resources available within computer system 100. As will be appreciated by those skilled in the art, computer system 100 may also include additional hardware coupled to system bus 146 that is not necessary for an understanding of the present invention and is accordingly omitted for simplicity.

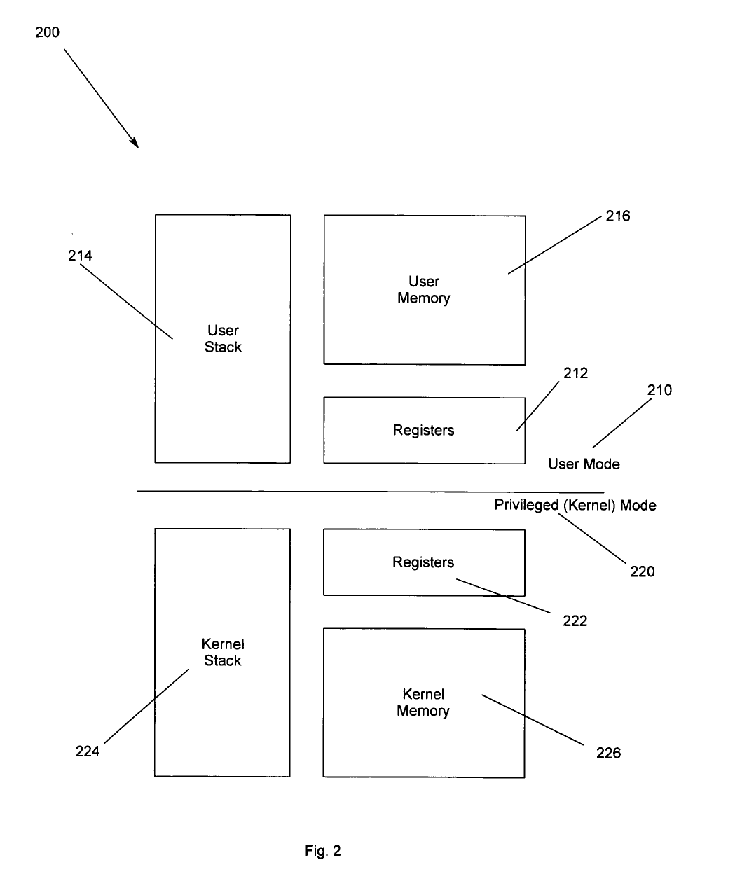

FIG. 2 shows the user mode and kernel mode states 200 according to an embodiment of the present invention. In FIG. 2, a user mode 210 and kernel mode 220 are shown. Applications and subsystems run on the computer in user mode 210. Processes that run in user mode 210 do so within their own virtual address spaces. They are restricted from gaining direct access to many parts of the system, including system hardware, memory not allocated for user mode 210, and other portions of the system that might compromise system integrity.

Processes that run in kernel-mode 220 can directly access system data and hardware, and are not restricted like processes running in user-mode 210. Performance-sensitive drivers and services run in kernel mode 220 to interact with hardware more efficiently. All components for processes running in kernel-mode 220 are fully protected from applications running in user mode 210. Processes that run in user mode 210 are effectively isolated from processes running in kernel-mode 220 and other processes running in user-mode 210.

In FIG. 2, a thread for a process running in user mode 210 is characterized as having its own context including registers 212 and memory stack 214. A user stack 214 is a data structure that includes a series of memory locations and a pointer to the initial location. All processors provide instructions for placing and retrieving values to and from the stack 214. The user memory 216 is a block of memory that is dedicated to the use of a current process running in user mode 210. A complete user state of a thread is maintained in user registers 212.

The kernel operates in its own protected address space and includes its own registers 222 and kernel stack 224. The kernel maintains the integrity of its own data structures and that of other processes. The kernel stack 224 includes information used by the kernel. Kernel memory 226 is generally shared by all processes, but is only accessible in kernel mode 220. Context switches from one task to another happen on the kernel stack 214 of the current process.

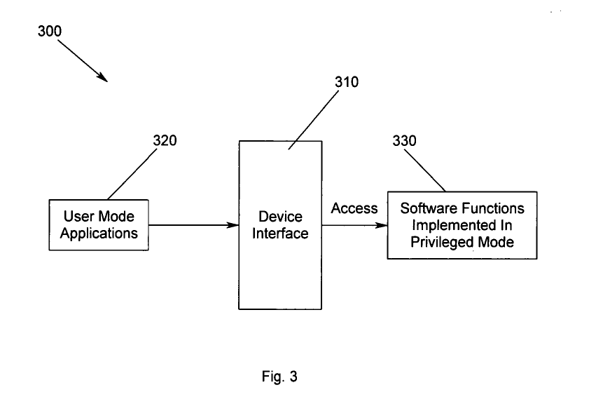

FIG. 3 illustrates an architecture of a computer system 300. In FIG. 3, a device interface 310 is shown disposed between user mode applications 320 and software functions running in privileged mode 330 (e.g., kernel mode). The device interface 310 provides an interface for all applications running in user mode 320 to access software functions implemented in privileged mode 330. However, the device interface 310 is not available to invoke these same software functions if they are to be modified to run in user mode.

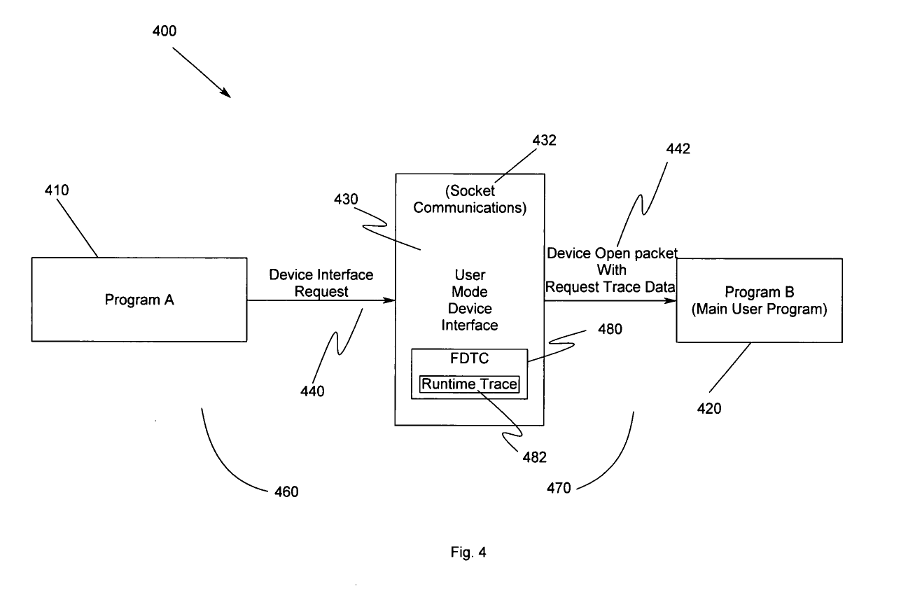

FIG. 4 is a diagram showing operation of user mode device interface 400 according to an embodiment of the present invention. In FIG. 4, user mode device interface 430 provides a socket communication path between processes of a first application running in a user mode 410 and a main user application 420 running on the server side 470 in privileged mode. The user mode device interface 430 allows device interface requests 440 to be sent and received, including commands 442 and data structures 444, via socket communication 432. The client side 460 of the socket interface 432 simply connects to the server side 470 to send and receive data, i.e., send requests for trace data and receive trace data. The server side 470 of the socket interface 432 accepts incoming connections.

As shown in FIG. 4, the first application 410 wants to use software functions of the second application 420, i.e., the main user application 420. According to an embodiment of the present invention, the user mode device interface 430 enables software functions 420 to be reused and re-implemented. The user mode device interface 430 provides a consistent interface to invoke the functions of the main user application 420. The user mode device interface 430 provides a utility program via the First Time Data Capture (FTDC) functions 480 to take advantage of the trace facility 422 of the main user application 420. The trace facility 422 of the main user application 420 is making traces in runtime trace buffers without any burden on the memory of the file systems, i.e., the compact flash of the file system. Since the runtime trace facility 482 is part of the overall FTDC 480, the runtime trace facility 482 automatically gets the benefit of the built-in memory management already in place in the main user application 420.

The user mode device interface 430 provides Request Trace Data (RTD) as part of the special “Device Open” data packet 442 sent to the main application 420 when a device interface request 440 is made. A Device Open data packet 442 sent in the device interface request 440 to the main user application 420 opens a device. A Device Open data packet 442 can be issued by any utility program 410 that wishes to open a connection and to reserve a device. The main application 420 then incorporates the RTD in its existing traces already in place in a built-in trace buffer. Accordingly, the process can be viewed as the main user application 420 is making a trace on behalf of a utility program in one of the internal trace buffers on the server side 470 of the socket interface 432.

Each request 442 is matched with the proper program on the server side 420. Since the RTD is sent to main application 420 by a utility program 410 when a device interface request 440 is made, the request 332 is automatically synchronized with all the activity on the server side 470 to handle this request. This helps the debug activity tremendously compared to trying to align a utility log file with trace data from the server side 470 and the effort to match-up between significantly different time stamp mechanisms provided by the main user application 420. Since the runtime tracing by the main user application 420 is performed in memory space, there is no burden on the memory of the file systems in terms of wearing out memory life cycle or usage of memory space. The performance of making such traces by the main user application 420 is much better than providing file input/output with text strings by the utility program 410.

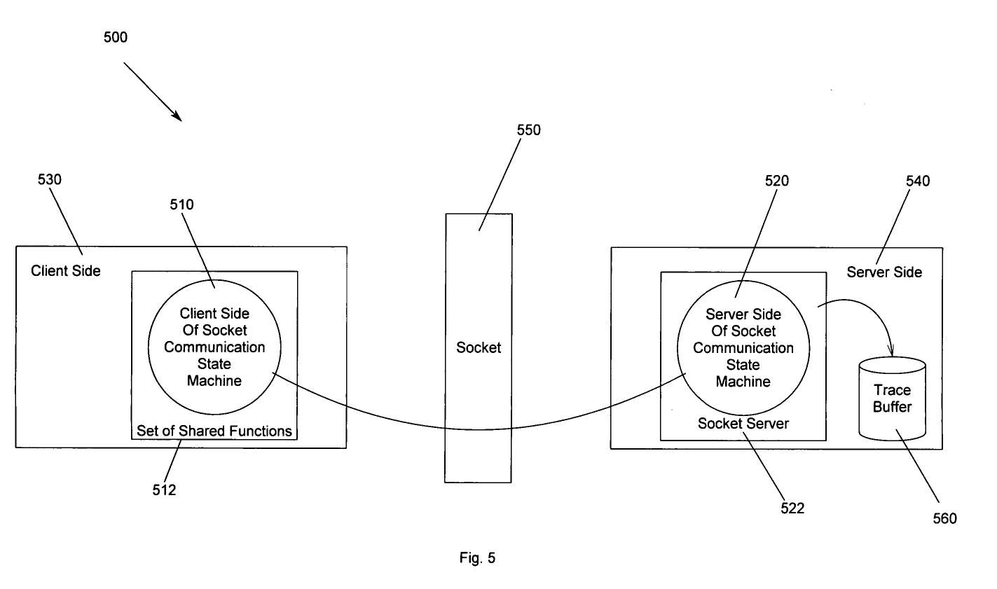

FIG. 5 illustrates interactions 500 between a client side, a server side and a user device interface according to an embodiment of the present invention. In FIG. 5, the user mode device interface includes device state machines 510, 520 that are implemented on both client 530 and server 540 sides of the socket 550 to satisfy device interface requirements. In FIG. 5, a device state machine on the client (requestor making requests) side 510 is implemented in a set of shared functions 512 that can be incorporated by all applications that want to communicate to a particular user program on the server side 540. The server side 540 offers the software functions over a user mode device interface via socket communication 550. The device state machine on the server side 520 is embedded in the socket server implementation 522. The interaction between the state machines 510, 520 on both client 530 and server 540 sides ensures a device interface request is properly handled.

In FIG. 5, when utility program on the client side 530 makes a request to a main user application on the server side 540, a shared function is called. A Device Open data packet is first sent to the server side 540, which signals the server side that a device interface request is coming. By expanding the Device Open data packet to include Request Trace Data in its data area, the server side uses the passed-in data to make a trace entry in its trace buffers 560.

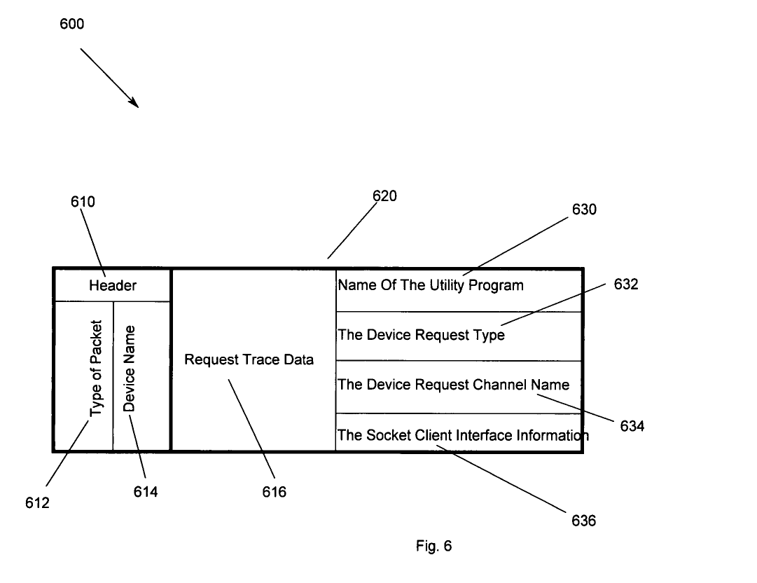

FIG. 6 illustrates a data packet structure 600 for providing a trace utility for a user device interface according to an embodiment of the present invention. The data packets 600 are communicated over the user mode interface in order to conduct a device interface request to the main program on the server side. All data packets 600 share a common header structure 610 and may include data 620. The data packet 600 specifies a packet type 612, a device name 614 and Request Trace Data 616. The Request Trace Data 616 may include the name of the utility program 630, the device request type 632, the device request channel name 634 and the socket client interface information 636.

The Request Trace Data 616 may be expanded to include other traces by a utility program as long as it is information available at the time when a device interface request is made. However, the Request Trace Data 616 is typically not intended as a general purpose trace facility for the utility program (socket client) to use. The trace point is only limited to when a Device Open packet is sent to the server side.

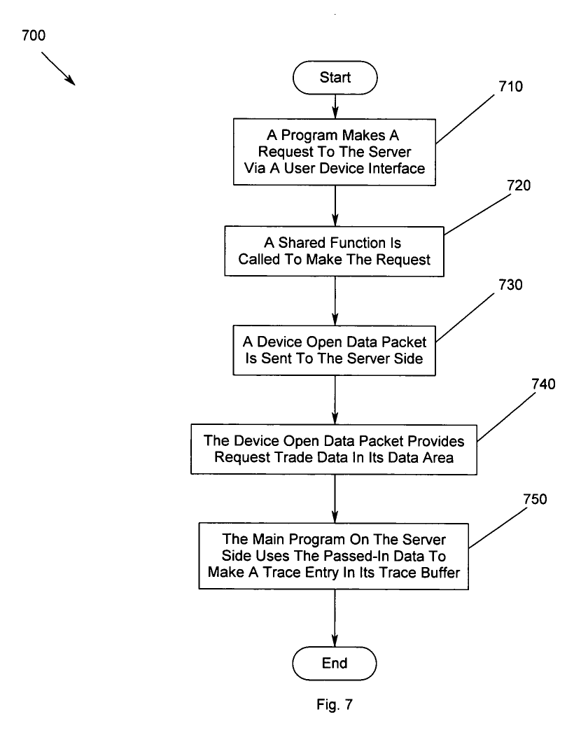

FIG. 7 is a flow diagram 700 of a method for providing a trace utility for a user device interface. In FIG. 7, a program makes a request to the server via a user device interface 710. A shared function is called to make the request 720. A Device Open data packet is sent to the server side 730. The Device Open data packet provides Request Trade Data in its data area 740. The main program on the server side uses the passed-in data to make a trace entry in its trace buffer 750.

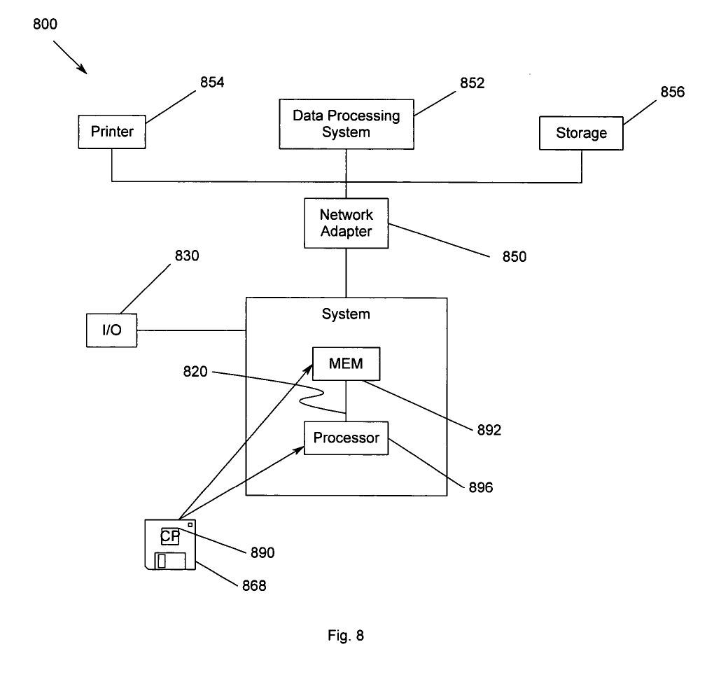

FIG. 8 illustrates a system 800 according to an embodiment of the present invention. Embodiments of the present invention may take the form of an entirely hardware embodiment, an entirely software embodiment or an embodiment containing both hardware and software elements. In a preferred embodiment, the invention is implemented in software, which includes but is not limited to firmware, resident software, microcode, etc. Furthermore, embodiments of the present invention may take the form of a computer program product 890 accessible from a computer-usable or computer-readable medium 868 providing program code for use by or in connection with a computer or any instruction execution system.

For the purposes of this description, a computer-usable or computer readable medium 868 can be any apparatus that can contain, store, communicate, propagate, or transport the program for use by or in connection with the instruction execution system, apparatus, or device. The medium 868 may be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A system suitable for storing and/or executing program code will include at least one processor 896 coupled directly or indirectly to memory elements 892 through a system bus 820. The memory elements 892 can include local memory employed during actual execution of the program code, bulk storage, and cache memories which provide temporary storage of at least some program code in order to reduce the number of times code must be retrieved from bulk storage during execution.

Input/output or I/O devices 840 (including but not limited to keyboards, displays, pointing devices, etc.) can be coupled to the system either directly to the system or through intervening I/O controllers.

Network adapters 850 may also be coupled to the system to enable the system to become coupled to other data processing systems 852, remote printers 854 or storage devices 856 through intervening private or public networks 860. Modems, cable modem and Ethernet cards are just a few of the currently available types of network adapters.

Accordingly, the computer program 890 comprise instructions which, when read and executed by the system 800 of FIG. 8, causes the system 800 to perform the steps necessary to execute the steps or elements of the present invention

The foregoing description of the embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A user mode device interface comprising a trace utility for generating a device open packet having request trace data therein for forwarding to a main user application trace facility in response to receipt of a device interface request from a client application.

2. The user mode device interface of claim 1, wherein the device open packet having request trace data therein causes a trace entry to be created in a trace buffer of a main user application.

3. The user mode device interface of claim 2, wherein the request trace data includes a name of a program making the device interface request, a device request type, a device request channel name and socket client interface information.

4. The user mode device interface of claim 1, wherein the request trace data includes a name of a program making the device interface request, a device request type, a device request channel name and socket client interface information.

5. The user mode device interface of claim 1, wherein the request trace data includes all trace information available at a time when the device interface request is made.

6. The user mode device interface of claim 1, wherein the request trace data enables a trace to be performed without ay burden on a file system of a client.

7. The user mode device interface of claim 1, wherein the request trace data synchronizes with all activity in trace buffers of the main user application.

8. A computing system, comprising:
a processor having a user mode and a protected kernel mode; and
a memory, coupled to the processor, the memory including program code, executing in the processor, for providing a user mode device interface, the user mode device interface processing a device interface request by generating a device open packet having request trace data therein for forwarding to a main user application trace facility in response to receipt of a device interface request from a client application.

9. The computing system of claim 8, wherein the device open packet having request trace data therein causes a trace entry to be created in a trace buffer of a main user application.

10. The computing system of claim 9, wherein the request trace data includes a name of a program making the device interface request, a device request type, a device request channel name and socket client interface information.

11. The computing system of claim 8, wherein the request trace data includes a name of a program making the device interface request, a device request type, a device request channel name and socket client interface information.

12. The computing system of claim 8, wherein the request trace data includes all trace information available at a time when the device interface request is made.

13. The computing system of claim 8, wherein the request trace data enables a trace to be performed without ay burden on a file system of a client.

14. The computing system of claim 8, wherein the request trace data synchronizes with all activity in trace buffers of the main user application.

15. A program storage device, comprising:
program instructions executable by a processing device to perform operations for providing a user mode device interface for providing request trace data, the operations comprising:
generating a device open packet having request trace data therein in response to receipt of a device interface request from a client application; and
forwarding the device open packet having request trace data therein to a main user application trace facility.

16. The program storage device of claim 16 further comprising creating a trace entry in a trace buffer of a main user application.

17. The program storage device of claim 16, wherein the generating a device open packet having request trace data therein further comprises generating a name of a program making the device interface request, a device request type, a device request channel name and socket client interface information.

18. The program storage device of claim 16, wherein the generating a device open packet having request trace data therein further comprises generating a request trace data that includes all trace information available at a time when the device interface request is made.

19. The program storage device of claim 16 further comprises performing a trace associated with the request trace data without placing any burden on a file system of a client.

20. The program storage device of claim 16 further comprises synchronizing the trace associated with the request trace data with all activity in trace buffers of the main user application.
